(19) United States
(12) Patent Application Publication
(10) Pub. No.: US 2018/0330118 A1
(43) Pub. Date: Nov. 15, 2018

(54) METHODS AND SYSTEMS FOR INTELLIGENTLY CONDUCTING ENCRYPTION IN CHAT ROOM COMMUNICATIONS

(71) Applicant: Ping Kwan Leung, Hong Kong (HK)

(72) Inventor: Ping Kwan Leung, Hong Kong (HK)

(21) Appl. No.: 15/590,904

(22) Filed: May 9, 2017

(51) Int. Cl. G06F 21/62; H04L 29/06; H04L 9/08

(52) U.S. Cl. CPC G06F 21/6263; H04L 9/088; H04L 63/0428

(57) ABSTRACT

According to embodiments of the invention, systems and methods are directed to an intelligent, real-time security protocol for encrypting certain communications which may be deemed to contain sensitive information. The disclosed technology may be carried out automatically or semi-autonomously. Systems and methods generally involve detecting which, if any, contents of a transmitted message contain sensitive information, which, if sent, may pose a security threat to the sender or another user. The disclosed technology may be carried out using a network node, server, computing device and/or any other apparatus or service for storing and transmitting information. The method may be carried out by a processor and computer readable storage medium. Software adapted to be used on a given computing device or via the web may be the platform from which the encryption is carried out.

### FIELD OF THE INVENTION

The invention relates generally to online privacy & security, and more specifically, to automated encryption of certain sensitive communications sent between internet users.

### BACKGROUND OF THE INVENTION

Chat rooms generally refer to communication channels, usually dedicated to a particular topic or shared interest, where one user can communicate and share information with one or more other users online, in real-time. Chat rooms are also widely used in a variety of commercial or business applications pre-sales or after-sales service indispensable service system, and the ability to securely transmit data including personal sensitive information has a high commercial value and is necessary to carry out certain online transactions and exchanges.

In order to attract customers to buy products or services, an online consumer or transactional service must inspire confidence by consumers in their brand and their ability to facilitate smooth and secure transactions. Most of the time, the successful facilitation of a chat room hinges on security. The challenge does not solely come from the platform. Instead, it is the message sender that may cause the problems, regardless of whether these problems are apparent to the sender.

Providers of chat room services should not assume all users can exercise their own judgment in sending information over chat rooms. Some users are sophisticated and they may be very careful in sending information through electronic communication channels. Others, however, are less sophisticated in identifying possible threats or risks before deciding what to send to the receiving party.

Aside from sending trivial information, a normal user may sometimes send sensitive information over a chat or messaging interface. Such information may consist of personal data such as identifying information, bank account numbers, or even system passwords. This puts a lot of responsibility on the chat room provider as hackers can find ways to intercept the information throughout the communication channel, including the sourcing medium, communication medium, and also the destination medium. Therefore, it is imperative for chat interface and online messaging providers to minimize the risk for unsophisticated users sending sensitive information over the corresponding communications channels.

As such, there exists a need for an intelligent, real-time security protocol method for encrypting certain communications which may be deemed to contain sensitive information.

### SUMMARY OF THE INVENTION

According to embodiments of the invention, systems and methods are directed to an intelligent, real-time security protocol for encrypting certain communications which may be deemed to contain sensitive information. The disclosed technology may be carried out automatically or semi-autonomously. Systems and methods generally involve detecting which, if any, contents of a transmitted message contain sensitive information, which, if sent, may pose a security threat to the sender or another user. The disclosed technology may be carried out using a network node, server, computing device and/or any other apparatus or service for storing and transmitting information. The method may be carried out by a processor and computer readable storage medium. Software adapted to be used on a given computing device or via the web may be the platform from which the encryption is carried out. The method may be employed in varying online or mobile communication platforms. The method may be retroactively applied to existing communications interfaces in order to render them more secure.

In one embodiment, a method is provided for intelligently conducting encryption during online communications. The method may be carried out, not necessarily in the following order, by: a) receiving text currently entered by a sending user using a sender module, wherein the text contains sensitive information and non-sensitive information; b) receiving a ‘send’ command from the sending user within the sender module; c) screening the text within the sender module, wherein any screened text perceived to be containing sensitive information is sent to a logic analyzer for further processing of the sensitive information into a modified text format; d) carrying out the delivery of the portion of the text containing the non-sensitive information through a communication channel; e) sending the modified text via the communication channel; f) receiving, by a receiving user via a receiving module, the text and the modified text; g) processing the modified text with the logic analyzer before displaying the sensitive information to the receiving user; displaying the text containing the non-sensitive information to the receiving user; and/or h) displaying the modified text to the receiving user.

The aforementioned logic analyzer within the sender module encrypts the text when processing the sensitive information into the modified text. Alternatively, the the logic analyzer within the sender module decrypts the text when processing the modified text before displaying the contents to the receiving user. The logic analyzer may notify the sending user upon detection of existence of possible sensitive information entered by the sending user. Still further, the logic analyzer may send confirmation to the sending user upon detection of existence of the sensitive information entered by the sending user.

In another embodiment of the disclosed technology, alternative methods are provided for intelligently conducting encryption during online communications. The method may be carried out, not necessarily in the following order, by: receiving text entered by a sending user via a sender module, wherein the text contains sensitive information and non-sensitive information, further wherein the sending user belongs to a user category; b) receiving a ‘send’ command from the sending user within the sender module; c) screening the text within the sender module, wherein any screened text containing the sensitive information is sent to a logic analyzer for further processing, wherein the processing entails modifying the sensitive information to a modified text format based on the user category of the sending user; d) sending the text containing the non-sensitive information through a communication channel; e) sending the modified text through the communication channel; f) receiving, by a receiving user via a receiving module, the text and the modified text; g) processing the modified text with the logic analyzer based on the user category of the sending user before displaying output information to the receiving user; h) displaying the text containing the non-sensitive information to the receiving user; and/or i) displaying the displaying output information to the receiving user.

In a further embodiment, the logic analyzer within the sender module may encrypt the text when processing the sensitive information into the modified text format only if the sending user belongs to a high security user category. Still further, the logic analyzer within the sender module may conduct a stronger encryption mechanism with the text when processing the sensitive information into the modified text format only if the sending user belongs to a user category with a designated high security level.

In still further embodiments of the disclosed technology, The logic analyzer within the sender module may conduct a weaker encryption mechanism with the text when processing the sensitive information into the modified text format only if the sending user belongs to a user category with a designated lower security level. The logic analyzer within the sender module may notify the sending user upon detection of possibly sensitive information detected in the text desired to be sent.

A better understanding of the disclosed technology will be obtained from the following brief description of drawings illustrating exemplary embodiments of the disclosed technology.

### BRIEF DESCRIPTION OF THE DRAWINGS

FIG. 1 shows a visualization of a chat interface according to embodiments of the disclosed technology.

FIG. 2 shows a chat interface visualization with a sensitive text transmission according to embodiments of the disclosed technology.

FIG. 3 shows a chat interface visualization with a sensitive text transmission having been encrypted according to embodiments of the disclosed technology.

FIG. 4 shows a flow chart outlining steps of a method of encrypting sensitive portions of a text transmission according to embodiments of the disclosed technology.

FIG. 5 shows a flow chart outlining steps of a method of encrypting sensitive portions of a text transmission based on designated user security category according to embodiments of the disclosed technology.

FIG. 6 shows a flow chart outlining steps of an alternative method of encrypting sensitive portions of a text transmission based on designated user security category according to embodiments of the disclosed technology.

FIG. 7 is a high-level block diagram of a microprocessor device that may be used to carry out the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

According to embodiments of the invention, systems and methods are directed to an intelligent, real-time security protocol for encrypting certain communications which may be deemed to contain sensitive information. The disclosed technology may be carried out automatically or semi-autonomously. Systems and methods generally involve detecting which, if any, contents of a transmitted message contain sensitive information, which, if sent, may pose a security threat to the sender or another user. The disclosed technology may be carried out using a network node, server, computing device and/or any other apparatus or service for storing and transmitting information. The method may be carried out by a processor and computer readable storage medium. Software adapted to be used on a given computing device or via the web may be the platform from which the encryption is carried out. The method may be employed in varying online or mobile communication platforms. The method may be retroactively applied to existing communications interfaces in order to render them more secure.

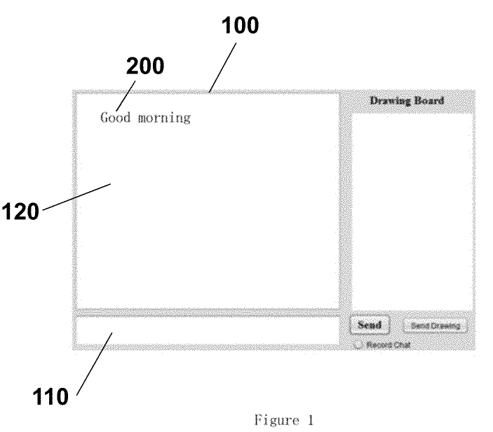

Referring now to FIG. 1, a visualization is shown of a chat interface according to embodiments of the disclosed technology. In the example shown, the chat interface 100 is depicted as a window or module that is similar to that of conventional chat interfaces known in the art. The chat interface 100 may be, for example, carried out via a web browser on a computing device. Alternative, the chat interface 100 may be part of a software application installed on a computing device. The computing device may be any device with processor, memory and network connectivity, such as, but not limited to, a notebook, a desktop computer, a mobile phone, a phablet, a tablet computer, or any other device known in the art.

The chat interface 100 has a sent message field 120 whereby any messages sent or received are shown. The chat interface also has a text input field 110 whereby a user may type messages that are desired to be sent to a receiver or a group of receivers in a chat environment. Also depicted is an example of a chat message 200 that may be sent via the interface.

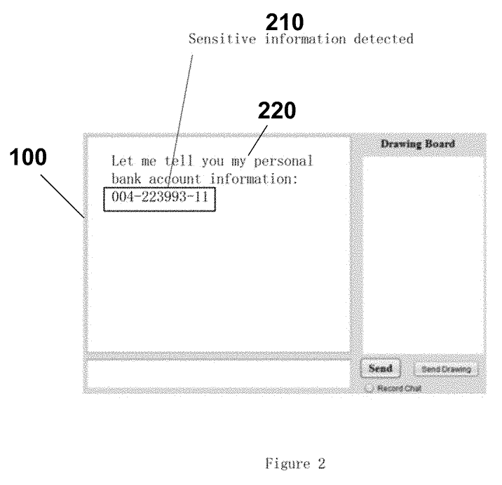

FIG. 2 shows a chat interface visualization with a sensitive text transmission according to embodiments of the disclosed technology. In this example, a text-contained message has been desired to be sent by a user. Portions of the message contain non-sensitive text 220, while other portions contain sensitive text 210. The disclosed method strives to identify the sensitive portions of the text automatically. That is, the interface may use contextual information and clues to detect possible sensitive text. For example, if a sentence contains a string of numbers and the words “bank” and “account” are detected in the same sentence, the interface may reasonably conclude that the string of numbers is representative of a bank account number or some other sensitive, identifying number. As such, in the example shown in FIG. 2, the string of numbers has been identified as possible detected sensitive information. As such, that string of numbers may be encrypted or otherwise modified in accordance with the methods of the disclosed technology.

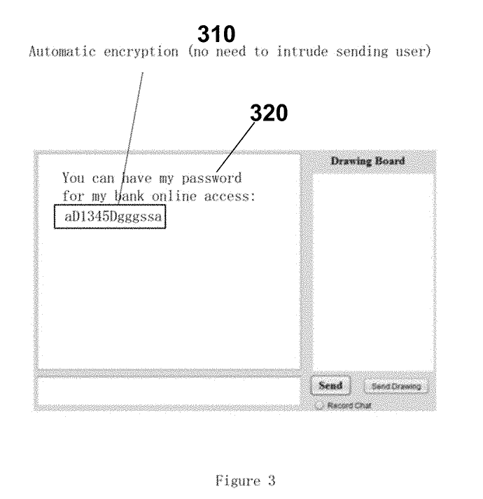

FIG. 3 shows a chat interface visualization with a sensitive text transmission having been encrypted according to embodiments of the disclosed technology. In this example, the sensitive information 310 being transmitted is automatically identified and encrypted, while the non-sensitive text 320 is left untouched, but used as context for identifying the sensitive information 310.

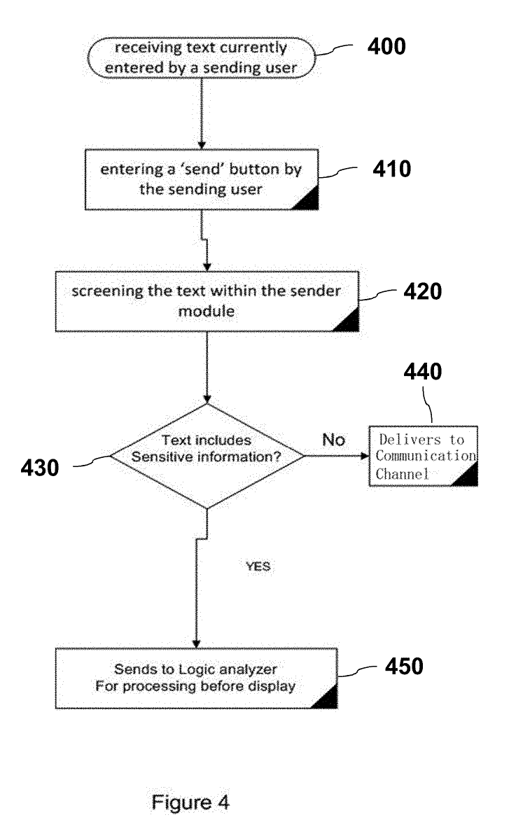

FIG. 4 shows a flow chart outlining steps of a method of encrypting sensitive portions of a text transmission according to embodiments of the disclosed technology. The method may be carried out by: 400) receiving text currently entered by a sending user using a sender module, wherein the text contains sensitive information and non-sensitive information; 410) receiving a ‘send’ command from the sending user within the sender module; 420) screening the text within the sender module; 430) determining if the text contains sensitive information; 440) carrying out the delivery of the portion of the text containing the non-sensitive information through a communication channel; and/or 450) sending the modified text via the communication channel.

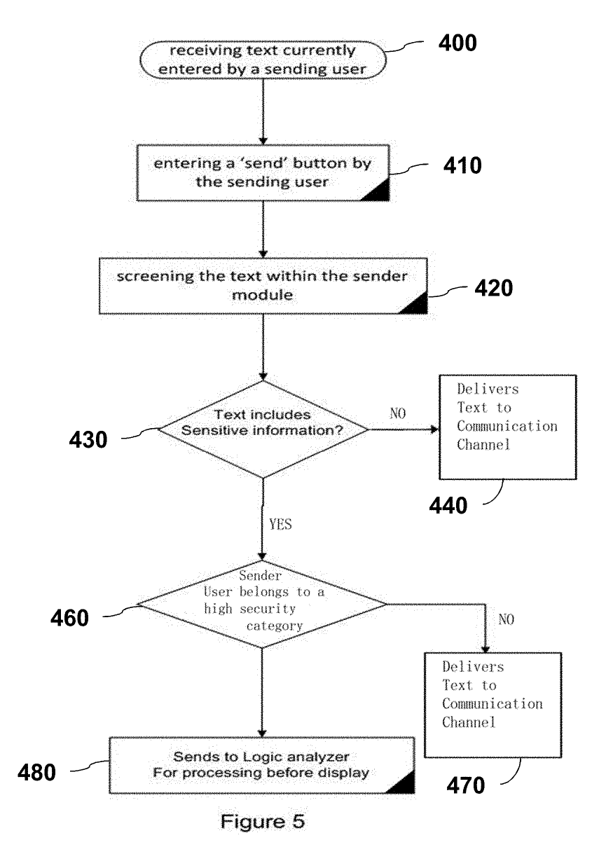

FIG. 5 shows a flow chart outlining steps of a method of encrypting sensitive portions of a text transmission based on designated user security category according to embodiments of the disclosed technology. The method may be carried out, not necessarily in the following order, by: 400) receiving text currently entered by a sending user using a sender module, wherein the text contains sensitive information and non-sensitive information; 410) receiving a ‘send’ command from the sending user within the sender module; 420) screening the text within the sender module; 430) determining if the text contains sensitive information; 440) carrying out the delivery of the portion of the text containing the non-sensitive information through a communication channel; 460) determining whether the sender/user belongs to a high security category; 470) if the user his not a high security user, then the text is delivered through the normal communication channels; and 480) if the user is in a high security category, the text is sent to a logic analyzer for processing and/or encryption before it is displayed to the recipient.

A user in the high security category may be a user that has been designated as such based on prior behavior. For example, if the user has previously disclosed sensitive data improperly to someone's detriment, that user may be designated as a high risk user. In other words, that user is designated as being more prone to accidentally or unwittingly disclosing sensitive information.

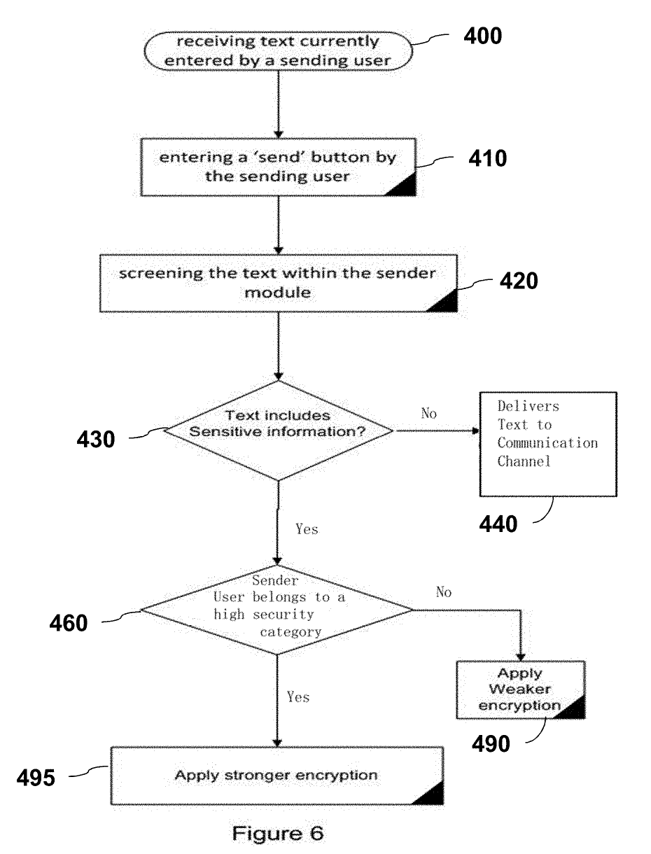

FIG. 6 shows a flow chart outlining steps of an alternative method of encrypting sensitive portions of a text transmission based on designated user security category according to embodiments of the disclosed technology. This method may be carried out by: 400) receiving text currently entered by a sending user using a sender module, wherein the text contains sensitive information and non-sensitive information; 410) receiving a ‘send’ command from the sending user within the sender module; 420) screening the text within the sender module; 430) determining if the text contains sensitive information; 440) carrying out the delivery of the portion of the text containing the non-sensitive information through a communication channel; 460) determining whether the sender/user belongs to a high security category; 490) if the user his not a high security user, then weaker encryption is applied to the detected sensitive text; and 495) if the user is in a high security category, then stronger encryption is applied to the detected sensitive text.

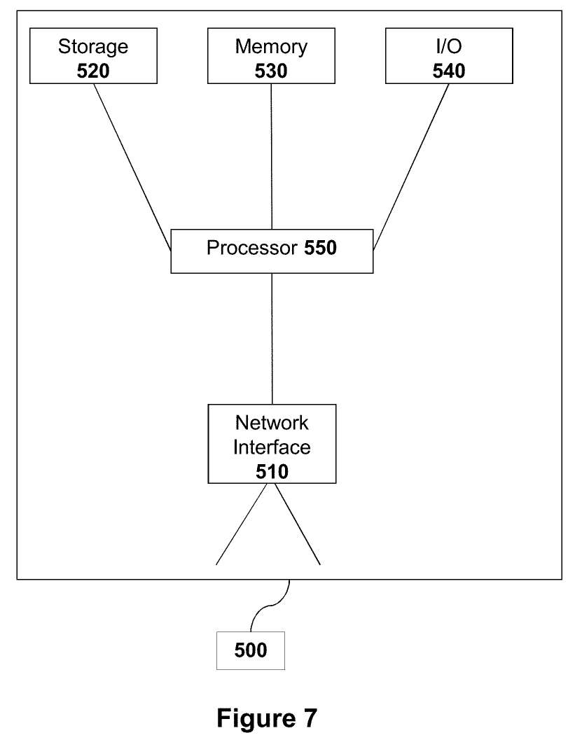

FIG. 7 is a high-level block diagram of a microprocessor device that may be used to carry out the disclosed technology. The device 500 comprises a processor 550 that controls the overall operation of a computer by executing the reader's program instructions which define such operation. The reader's program instructions may be stored in a storage device 520 (e.g., magnetic disk, database) and loaded into memory 530 when execution of the console's program instructions is desired. Thus, the device 500 will be defined by the program instructions stored in memory 530 and/or storage 520, and the console will be controlled by processor 550 executing the console's program instructions.

The device 500 may also include one or a plurality of input network interfaces for communicating with other devices via a network (e.g., the internet). The device 500 further includes an electrical input interface for receiving power and data. The device 500 also includes one or more output network interfaces 510 for communicating with other devices. The device 500 may also include input/output 540 representing devices which allow for user interaction with a computer (e.g., display, keyboard, mouse, speakers, buttons, etc.).

In a further embodiment, the logic analyzer within the sender module may encrypt the text when processing the sensitive information into the modified text format only if the sending user belongs to a high security user category. Still further, the logic analyzer within the sender module may conduct a stronger encryption mechanism with the text when processing the sensitive information into the modified text format only if the sending user belongs to a user category with a designated high security level.

In still further embodiments of the disclosed technology, The logic analyzer within the sender module may conduct a weaker encryption mechanism with the text when processing the sensitive information into the modified text format only if the sending user belongs to a user category with a designated lower security level. The logic analyzer within the sender module may notify the sending user upon detection of possibly sensitive information detected in the text desired to be sent.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mutt,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

What is claimed:

1. A method for intelligently conducting encryption during online communications, comprising:
receiving text currently entered by a sending user using a sender module, wherein the text contains sensitive information and non-sensitive information;
receiving a ‘send’ command from the sending user within the sender module;
screening the text within the sender module, wherein any screened text perceived to be containing sensitive information is sent to a logic analyzer for further processing of the sensitive information into a modified text format;
carrying out the delivery of the portion of the text containing the non-sensitive information through a communication channel;
sending the modified text via the communication channel;
receiving, by a receiving user via a receiving module, the text and the modified text;
processing the modified text with the logic analyzer before displaying the sensitive information to the receiving user;
displaying the text containing the non-sensitive information to the receiving user; and
displaying the modified text to the receiving user.

2. The method of claim 1, wherein the logic analyzer within the sender module encrypts the text when processing the sensitive information into the modified text.

3. The method of claim 1, wherein the logic analyzer within the sender module decrypts the text when processing the modified text before displaying the contents to the receiving user.

4. The method of claim 2, wherein the logic analyzer notifies the sending user upon detection of existence of possible sensitive information entered by the sending user.

5. The method of claim 3, wherein the logic analyzer sends confirmation to the sending user upon detection of existence of the sensitive information entered by the sending user.

6. A method for intelligently conducting encryption during online communications, comprising:
receiving text entered by a sending user via a sender module, wherein the text contains sensitive information and non-sensitive information, further wherein the sending user belongs to a user category;
receiving a ‘send’ command from the sending user within the sender module;
screening the text within the sender module, wherein any screened text containing the sensitive information is sent to a logic analyzer for further processing, wherein the processing entails modifying the sensitive information to a modified text format based on the user category of the sending user;
sending the text containing the non-sensitive information through a communication channel;
sending the modified text through the communication channel;
receiving, by a receiving user via a receiving module, the text and the modified text;
processing the modified text with the logic analyzer based on the user category of the sending user before displaying output information to the receiving user;
displaying the text containing the non-sensitive information to the receiving user; and
displaying the displaying output information to the receiving user.

7. The method of claim 6, wherein the logic analyzer within the sender module encrypts the text when processing the sensitive information into the modified text format only if the sending user belongs to a high security user category.

8. The method of claim 6, wherein the logic analyzer within the sender module conducts a stronger encryption mechanism with the text when processing the sensitive information into the modified text format only if the sending user belongs to a user category with a designated high security level.

9. The method of claim 6, wherein the logic analyzer within the sender module conducts a weaker encryption mechanism with the text when processing the sensitive information into the modified text format only if the sending user belongs to a user category with a designated lower security level.

10. The method of claim 6, wherein the logic analyzer within the sender module notifies the sending user upon detection of possibly sensitive information detected in the text desired to be sent.
